(19) United States
(12) Patent Application Publication
(10) Pub. No.: US 2022/0013888 A1
(43) Pub. Date: Jan. 13, 2022

(54) VEHICLE ANTENNA

(71) Applicant: Yazaki Corporation, Tokyo (JP)

(72) Inventor: Kazuhiko TSUCHIYA, Shizuoka (JP)

(73) Assignee: Yazaki Corporation, Tokyo (JP)

(21) Appl. No.: 17/487,523

(22) Filed: Sep. 28, 2021

Related U.S. Application Data
(63) Continuation of application No. PCT/JP2020/016575, filed on Apr. 15, 2020.

(30) Foreign Application Priority Data
Apr. 23, 2019 (JP) 2019-081763

(51) Int. Cl. H01Q 1/32; H01Q 1/22; H01Q 9/40

(52) U.S. Cl. CPC H01Q 1/3275; H01Q 9/40; H01Q 1/22

(57) ABSTRACT

Provided is a vehicle antenna to be mounted on a vehicle. The vehicle antenna includes a first antenna portion configured to receive a radio wave signal, the first antenna portion being provided on a roof of the vehicle, and a second antenna portion configured to emit a radio wave signal into the vehicle, the second antenna portion being provided in the vehicle. The first antenna portion is a monopole antenna. The second antenna portion is a flat plate antenna. The first antenna portion and the second antenna portion are electrically connected to each other via a co-axial cable.

### CROSS-REFERENCE TO RELATED APPLICATIONS

The present application is a continuation of International Application No. PCT/JP2020/016575, filed on Apr. 15, 2020, and based upon and claims the benefit of priority from Japanese Patent Application No. 2019-081763, filed on Apr. 23, 2019, the entire contents of which are incorporated herein by reference.

### TECHNICAL FIELD

The disclosure relates to a vehicle antenna.

### BACKGROUND ART

Japanese Unexamined Patent Application Publication No. 2009-284366 discloses a technique relating to a roof antenna such as a shark-fin shaped antenna mounted on a roof, which deals with various types of wireless communication systems and devices relating to AM or FM radio broadcasts, the Global Positioning System (GPS), the Electronic Toll Collection System (ETC), the Vehicle Information and Communication System (VICS (registered trademark)), ground wave digital television broadcasts, inter-vehicle communication, and the like.

### SUMMARY

However, in a case of this roof antenna, it is required to lay an antenna cable connected to the antenna in a vehicle and to connect the antenna cable to a device in a system exemplified by those described above.

Thus, this causes inconvenience such as increase in cost as well as time-consuming work of laying the antenna cable.

Further, in a case of a mobile phone, a smartphone, or the like that cannot be directly connected to the antenna cable, radio waves are partially blocked due to a metal plate or the like constituting a vehicle body, which causes a problem of reception sensitivity degradation in the vehicle.

It is an object of the disclosure to provide a vehicle antenna capable of improving reception sensitivity of a mobile phone, a smartphone, or the like without requiring work of laying an antenna cable in a vehicle.

A vehicle antenna according to the disclosure is a vehicle antenna mounted on a vehicle. The vehicle antenna includes a first antenna portion configured to receive a radio wave signal, the first antenna portion being provided on a roof of the vehicle, and a second antenna portion configured to emit a radio wave signal into the vehicle, the second antenna portion being provided in the vehicle. The first antenna portion is a monopole antenna. The second antenna portion is a flat plate antenna. The first antenna portion and the second antenna portion are electrically connected to each other via a co-axial cable.

With this, a radio wave received by the first antenna portion can be emitted into the vehicle by the second antenna portion. Thus, reception sensitivity of a mobile phone, a smartphone, or the like can be improved without requiring work of laying an antenna cable in the vehicle.

The monopole antenna of the vehicle antenna according to the disclosure may be a shark-fin shaped antenna.

With this, an external radio wave can be received with high sensitivity without impairing the aesthetic appearance.

The flat plate antenna of the vehicle antenna according to the disclosure may include a dielectric body having a plate-like shape, a first electrode provided to one peripheral portion of the dielectric body, and a second electrode provided to the other peripheral portion facing the one peripheral portion of the dielectric body. The first electrode may be connected to one end of a core wire of the co-axial cable, and the second electrode may be connected to a part of an outer cover wire of the co-axial cable.

With this, a radio wave received by the first antenna can be emitted efficiently into the vehicle via the flat plate antenna.

The other end of the core wire of the co-axial cable of the vehicle antenna according to the disclosure may be connected t to the monopole antenna, and a part of the outer cover wire of the co-axial cable may be earth-connected to a conductive portion of a vehicle body.

With this, a radio wave received by the monopole antenna can be emitted efficiently into the vehicle via the flat plate antenna.

The second antenna portion of the vehicle antenna according to the disclosure may be arranged in a space formed between a ceiling plate and the roof of the vehicle.

With this, the second antenna portion can be arranged without reducing a cabin space.

According to the disclosure, there can be provided the vehicle antenna capable of improving reception sensitivity of a mobile phone, a smartphone, or the like without requiring work of laying an antenna cable in a vehicle.

### BRIEF DESCRIPTION OF DRAWINGS

FIG. 1 is a side view illustrating a vehicle on which a vehicle antenna according to an embodiment is mounted.

FIG. 2 is a top view illustrating the vehicle on which the vehicle antenna according to the embodiment is mounted.

FIG. 3 is a schematic configuration view illustrating a schematic configuration of the vehicle antenna according to the embodiment.

FIG. 4A is a sectional view illustrating a configuration example of a shark-fin shaped antenna constituting a part of the vehicle antenna according to the embodiment.

FIG. 4B is a sectional view illustrating a configuration example of the shark-fin shaped antenna constituting a part of the vehicle antenna according to the embodiment.

FIG. 5A is an antenna characteristic diagram of a first antenna portion.

FIG. 5B is an antenna characteristic diagram of the first antenna portion.

FIG. 5C is an antenna characteristic diagram of the first antenna portion.

FIG. 6A is an antenna characteristic diagram of a second antenna portion.

FIG. 6B is an antenna characteristic diagram of the second antenna portion.

FIG. 7 is a schematic configuration view illustrating a schematic configuration of a vehicle antenna in another configuration (Part 1).

FIG. 8 is a schematic configuration view illustrating a schematic configuration of a vehicle antenna in another configuration (Part 2).

### DESCRIPTION OF EMBODIMENTS

With reference to the drawings, a vehicle antenna AS according to this embodiment is described below in detail.

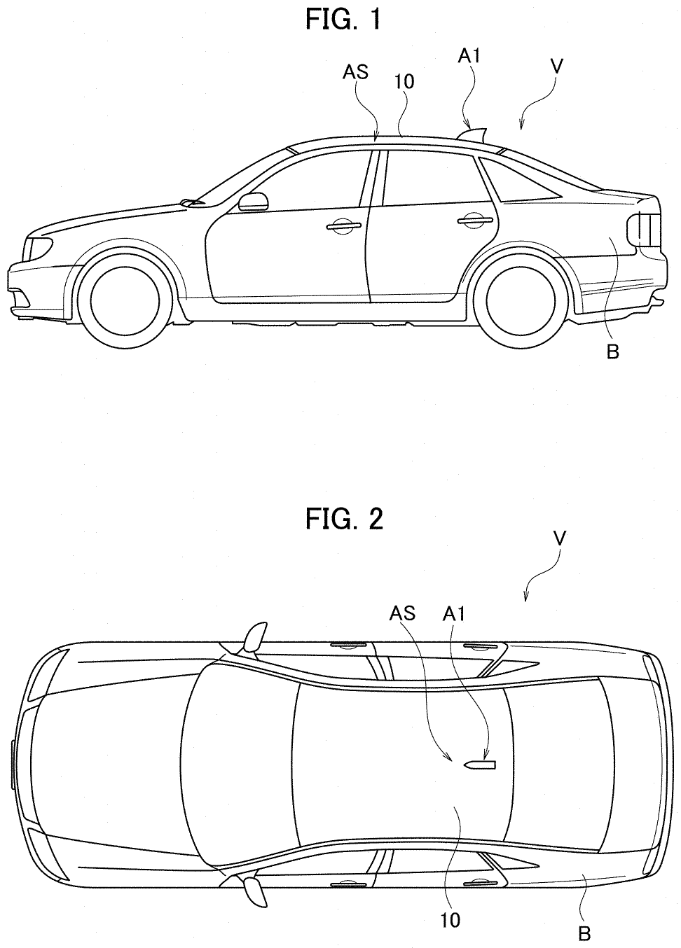

With reference to FIG. 1 to FIG. 8, one embodiment of the disclosure is described.

As illustrated in FIG. 1 and the like, a roof of a vehicle V is provided with a shark-fin shaped antenna (monopole antenna) A1 being a first antenna constituting a part of the vehicle antenna AS. The first antenna A1 has a function of receiving a radio wave outside the vehicle.

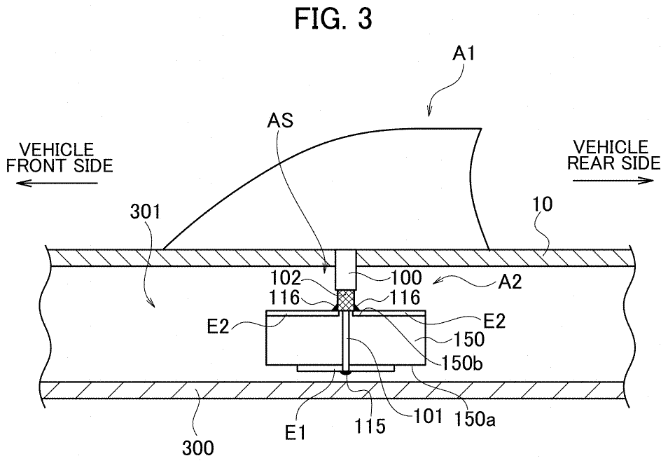

As illustrated in FIG. 3 and the like, the inside of the vehicle V is provided with a flat plate antenna (also referred to as a patch antenna or a micro-strip antenna) A2 being a second antenna constituting a part of the vehicle antenna AS. The second antenna A2 has a function of emitting a radio wave into the vehicle.

The first antenna portion A1 and the second antenna portion A2 are electrically connected to each other via a co-axial cable 100.

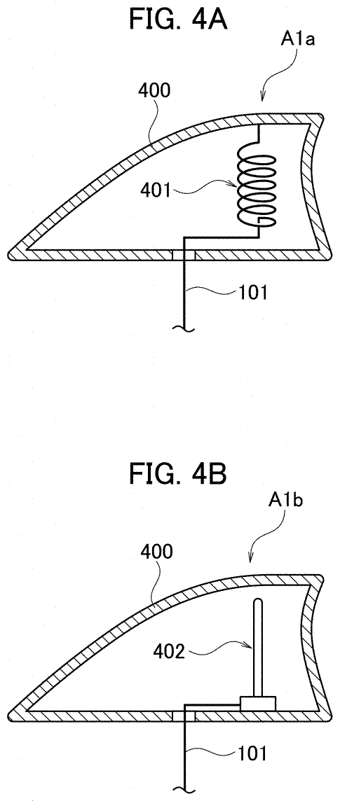

More specifically, as illustrated in FIG. 4A, a shark-fin shaped antenna (monopole antenna) Ala in one configuration example includes a shark-fin shaped casing, a coil-like antenna element 401 arranged in the casing 400, and the like. The lower end of the coil-like antenna element 401 is connected to a core wire 101 of the co-axial cable 100.

As illustrated in FIG. 4B, a shark-fin shaped antenna (monopole antenna) Alb in another configuration example includes the shark-fin shaped casing 400, a rod-like antenna element 402 arranged in the casing 400, and the like. The lower end of the rod-like antenna element 402 is connected to the core wire 101 of the co-axial cable 100.

Meanwhile, as illustrated in FIG. 3, the flat plate antenna A2 being the second antenna includes a dielectric body 150 having a plate-like shape (for example, a ceramic plate), a first electrode E1 provided to one peripheral portion 150a of the dielectric body 150, and a second electrode E2 provided to the other peripheral portion 150b facing the peripheral portion 150a of the dielectric body 150.

One end of the core wire 101 of the co-axial cable 100 is connected to the first electrode E1 by a joining portion 115 such as solder, and an outer cover wire 102 of the co-axial cable 100 is connected to the second electrode E2 by a joining portion 116 such as solder.

As described above, the other end of the core wire 101 of the co-axial cable 100 is connected to the antenna element 401 (402) of the shark-fin shaped antenna Ala (Alb), and a part of the outer cover wire 102 of the co-axial cable 100 is earth-connected to a conductive portion of a vehicle body B.

As illustrated in FIG. 3, in the vehicle antenna AS according to this embodiment, the second antenna portion A2 is arranged in a space 301 formed between a ceiling plate 300 and a roof 10 of the vehicle V, and hence the second antenna portion A2 can be arranged without reducing the cabin space.

In the second antenna portion A2, the flat plate surface of the plate-like dielectric body 150 may be parallel with the ceiling plate 300, and may be attached to the ceiling plate 300. With this, even when the space 301 is smaller, the second antenna portion A2 can be arranged while saving a space.

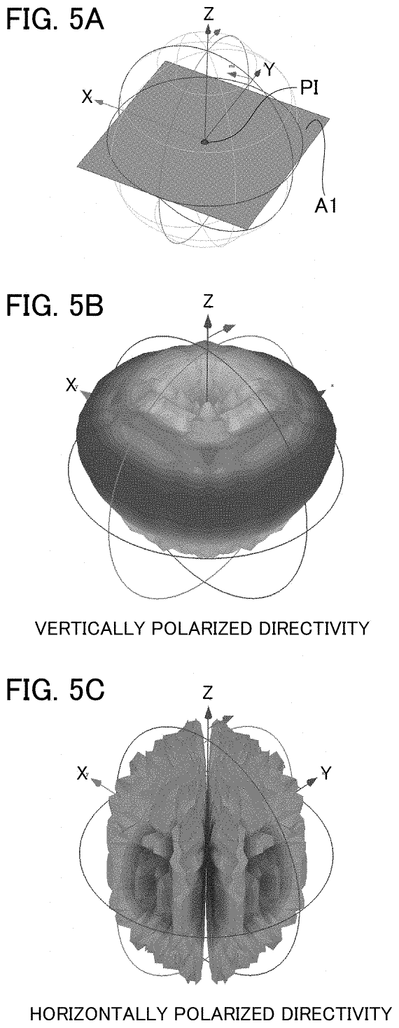

The first antenna portion A1 has antenna characteristics as illustrated in FIG. 5A to FIG. 5C.

FIG. 5A is a diagram showing orientation of the first antenna portion A1 and the like. FIG. 5B is a diagram showing vertically polarized directivity. FIG. 5C is a diagram showing horizontally polarized directivity.

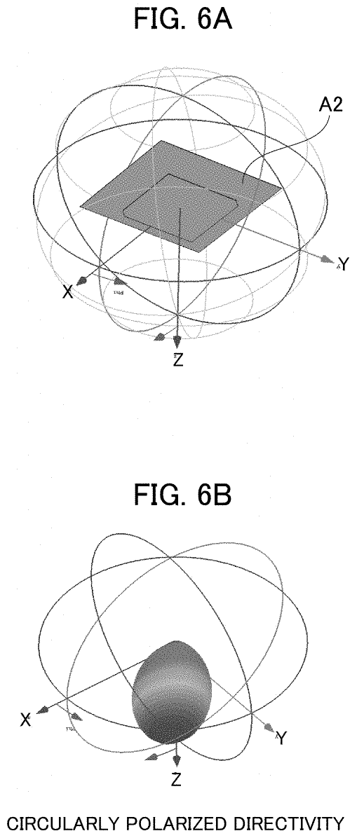

The second antenna portion A2 have antenna characteristics as illustrated in FIG. 6A and FIG. 6B.

FIG. 6A is a diagram showing orientation of the second antenna portion A2 and the like. FIG. 6B is a diagram showing circularly polarized directivity.

With this configuration, the vehicle antenna AS according to this embodiment is capable of causing the second antenna portion A2 to emit, into the vehicle, a radio wave received by the first antenna portion A1. Thus, reception sensitivity of a mobile phone, a smartphone, or the like can be improved without requiring work of laying an antenna cable in a vehicle.

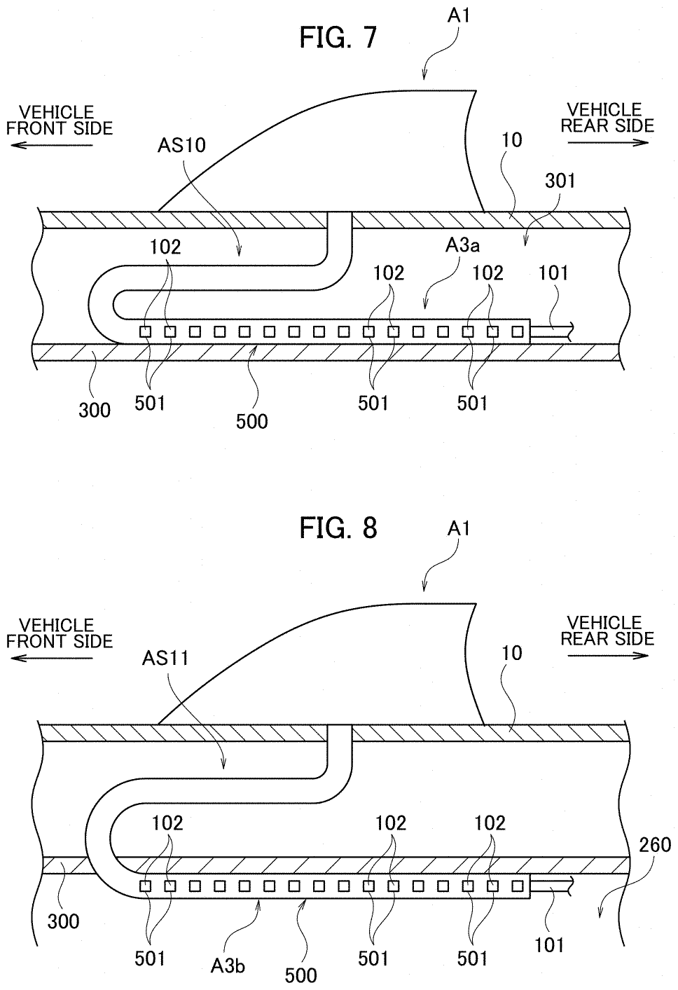

With reference to FIG. 7, configurations of a vehicle antenna AS10 in another configuration are described. Note that configurations similar to those of the vehicle antenna AS according to this embodiment are denoted with the same reference symbols, and overlapping description thereof is omitted.

In the vehicle antenna AS10, a leakage cable 500 being a second antenna A3a is arranged in place of the usual co-axial cable 100, in the space 301 between the roof 10 and the ceiling plate 300.

The leakage cable 500 is configured so that a cover portion is drilled to have a plurality of openings (slits) 501 and that the outer cover wire 102 is exposed from each of the openings (slits) 501.

With this, a radio wave received by the first antenna A1 is emitted into the vehicle through each of the openings (slits) 501 of the leakage cable 500 being the second antenna A3a.

Therefore, a radio wave received by the first antenna portion A1 can be emitted into the vehicle by the second antenna portion A3a. Thus, reception sensitivity of a mobile phone, a smartphone, or the like can be improved without requiring work of laying an antenna cable in a vehicle.

With reference to FIG. 8, configurations of a vehicle antenna AS11 in another configuration are described. Note that configurations similar to those of the vehicle antenna AS according to this embodiment are denoted with the same reference symbols, and overlapping description thereof is omitted.

In the vehicle antenna AS11, the leakage cable 500 being a second antenna A3b is arranged in place of the usual co-axial cable 100, along the vehicle inner side of the ceiling plate 300.

The leakage cable 500 is configured so that the cover portion is drilled to have the plurality of openings (slits) 501 and that the outer cover wire 102 is exposed from each of the openings (slits) 501.

With this, a radio wave received by the first antenna A1 is emitted into the vehicle through each of the openings (slits) 501 of the leakage cable 500 being the second antenna A3b.

Therefore, a radio wave received by the first antenna portion A1 can be emitted into the vehicle by the second antenna portion A3a. Thus, reception sensitivity of a mobile phone, a smartphone, or the like can be improved without requiring work of laying an antenna cable in a vehicle.

The vehicle antenna and the like of the disclosure are described above based on the illustrated embodiments. However, the disclosure is not limited thereto, and the configurations of the respective elements may be replaced with freely-selected configurations having similar functions.

The entire contents of Japanese patent application No. 2019-081763 (filed on Apr. 23, 2019) are herein invoked.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vehicle antenna to be mounted on a vehicle, the vehicle antenna comprising:
a first antenna portion configured to receive a radio wave signal, the first antenna portion being provided on a roof of the vehicle; and
a second antenna portion configured to emit a radio wave signal into the vehicle, the second antenna portion being provided in the vehicle, wherein
the first antenna portion comprises a monopole antenna,
the second antenna portion comprises a flat plate antenna, and
the first antenna portion and the second antenna portion are electrically connected to each other via a co-axial cable.

2. The vehicle antenna according to claim 1, wherein
the monopole antenna comprises a shark-fin shaped antenna.

3. The vehicle antenna according to claim 1, wherein
the flat plate antenna includes:
a dielectric body having a plate-like shape;
a first electrode provided to one peripheral portion of the dielectric body; and
a second electrode provided to another peripheral portion facing the one peripheral portion of the dielectric body,
the first electrode is connected to one end of a core wire of the co-axial cable, and
the second electrode is connected to a part of an outer cover wire of the co-axial cable.

4. The vehicle antenna according to claim 3, wherein
another end of the core wire of the co-axial cable is connected to the monopole antenna, and
a part of the outer cover wire of the co-axial cable is earth-connected to a conductive portion of a vehicle body.

5. The vehicle antenna according to claim 1, wherein
the second antenna portion is arranged in a space formed between a ceiling plate and the roof of the vehicle.
